(19) United States
(12) Patent Application Publication
(10) Pub. No.: US 2022/0237716 A1
(43) Pub. Date: Jul. 28, 2022

(54) METHODS AND SYSTEMS FOR MANAGING GOLF HOLE LOCATIONS ON A GOLF COURSE

(71) Applicant: DPP Golf Inc., Halifax (CA)

(72) Inventor: Gregory Hubley, Halifax (CA)

(21) Appl. No.: 17/582,417

(22) Filed: Jan. 24, 2022

Related U.S. Application Data
(60) Provisional application No. 63/140,992, filed on Jan. 25, 2021.

(51) Int. Cl. G06Q 50/16; G06Q 10/00; A63B 71/06

(52) U.S. Cl. CPC G06Q 50/163; G06Q 10/20; A63B 2102/32; A63B 2071/0691; A63B 71/0669

(57) ABSTRACT

Hole locations on a golf course are managed by identifying a plurality of physical golf greens and generating a course map that defines a perimeter of each green. Potential hole locations are identified for each green and associated with hole location coordinates. Each potential hole location is associated with a corresponding hole location score. A desired overall course score is identified and a set of golf hole locations for the plurality of physical golf greens is selected to provide the desired overall course score. The hole location coordinates of the selected hole locations are provided to a manager device to guide the cutting of golf holes on the plurality of physical golf greens.

### CROSS-REFERENCE TO RELATED APPLICATIONS

This application claims the benefit of U.S. Provisional Application No. 63/140,992 filed on Jan. 25, 2021, which is incorporated by reference herein in its entirety.

### FIELD

The described embodiments relate to golf course management, and in particular to systems and methods for managing golf hole locations on golf courses.

### BACKGROUND

The following is not an admission that anything discussed below is part of the prior art or part of the common general knowledge of a person skilled in the art.

Landscape management is crucial to ensuring a golf course remains in good condition. Every part of the course requires constant planning and upkeep to maintain good conditions over a golf season. The tee boxes, fairways, greens, bunkers and even the rough need to be looked after and managed to provide a consistent experience for golfers.

Maintaining engagement from returning golfers is also an important aspect of effective course management. Small changes to holes can provide new challenges that help keep returning golfers engaged. When properly managed, these changes can also ensure that the course remains in good condition for longer periods.

An important aspect of course maintenance is positioning the pin location for each hole. Pin locations have to be carefully managed and changed on a regular basis to ensure that greens are evenly worn. Changing pin locations also allows the golf course to adjust the difficulty level of individual holes. This can help keep golfers engaged when returning to play the same course.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with a broad aspect, there is provided a method of managing golf hole locations on a golf course, the method comprising: identifying a plurality of physical golf greens associated with the golf course; generating a map of the plurality of physical golf greens, wherein the map defines, for each physical golf green, a perimeter of that physical golf green; for each physical golf green: identifying a plurality of potential golf hole locations, wherein each potential golf hole location is associated with corresponding golf hole location data, wherein the golf hole location data corresponding to each potential golf hole location specifies golf hole location coordinates for that potential golf hole location within the perimeter of the corresponding physical golf green; associating each potential golf hole location with a corresponding golf hole location score, wherein, for each potential golf hole location, the corresponding golf hole location score is determined based on user scores received from a plurality of user devices while that potential golf hole location is in use; determining a plurality of available golf hole locations from the plurality of potential golf hole locations associated with that physical golf green by: identifying a plurality of recently used golf hole locations in the plurality of potential golf hole locations; and defining the plurality of available golf hole locations to include an available subset of the potential golf hole locations in the plurality of potential golf hole locations, wherein the available subset of the potential golf hole locations omits the plurality of recently used golf hole locations; identifying a desired overall course score for the golf course; selecting a set of selected golf hole locations, wherein the set of selected golf hole locations comprises a plurality of selected golf hole locations, wherein the plurality of selected golf hole locations comprises, for each physical golf green, one of the available golf hole locations, and the plurality of selected golf hole locations is selected such that a sum of the corresponding golf hole location scores corresponds to the desired overall course score; and providing a set of golf hole location coordinates to a manager device, wherein the set of golf hole location coordinates is defined by the golf hole location coordinates of the selected golf hole locations and the set of golf hole location coordinates is usable to guide the cutting of golf holes on the plurality of physical golf greens.

In accordance with this broad aspect, there is also provided a method of managing golf hole locations on a golf course, the method comprising: identifying a plurality of physical golf greens associated with the golf course; generating a map of the plurality of physical golf greens, wherein the map defines, for each physical golf green, a perimeter of that physical golf green; for each physical golf green: identifying a plurality of potential golf hole locations, wherein each potential golf hole location is associated with corresponding golf hole location data, wherein the golf hole location data corresponding to each potential golf hole location specifies golf hole location coordinates for that potential golf hole location within the perimeter of the corresponding physical golf green; and associating each potential golf hole location with a corresponding golf hole location score; identifying at least one desired overall course score for the golf course; selecting at least one set of selected golf hole locations for the golf course based on the at least one desired overall course score, wherein each set of selected golf hole locations comprises a plurality of selected golf hole locations, and the plurality of selected golf hole locations for each set of selected golf hole locations is selected such that a sum of the corresponding golf hole location scores correspond to the desired overall course score for that set of selected golf hole locations; and providing a set of golf hole location coordinates to a manager device, wherein the set of golf hole location coordinates is defined by the golf hole location coordinates of the selected golf hole locations of a particular set of selected golf hole locations and the set of golf hole location coordinates is usable to guide the cutting of golf holes on the plurality of physical golf greens.

In some examples, the method may include determining, for each physical golf green, a plurality of available golf hole locations from the plurality of potential golf hole locations associated with that physical golf green; and selecting the plurality of selected golf hole locations from the plurality of available golf hole locations; where for a given physical golf green, the plurality of available golf hole locations omits at least one of the potential golf hole locations for that physical golf green.

In some examples, for the given physical golf green, the plurality of available golf hole locations may be determined by omitting all potential golf hole locations previously selected for that physical golf green within a predefined timeframe.

In some examples, the at least one overall course score may include a single desired overall course score determined for a specified time frame.

In some examples, the at least one desired overall course score may include a plurality of desired overall course scores, where the plurality of desired overall course scores are selected for a sequence of specified time frames; and selecting at least one set of golf hole locations may include selecting a plurality of sets of selected golf hole locations corresponding to the plurality of desired overall course scores where each set of selected golf hole locations corresponds to one of the specified time frames in the sequence of specified time frames.

In some examples, the method may include generating the map of the plurality of physical golf greens using green location data that includes geolocation coordinates for the physical golf greens.

In some examples, the method may include defining the golf hole location coordinates for each potential golf hole location as an absolute geolocation coordinate using the green location data.

In some examples, the method may include for each physical golf green in the plurality of golf greens: receiving a plurality of user scores for a given potential golf hole location, where each user score is received from a user of the golf course, and each score corresponds to a score timeframe in which that given potential golf hole location is included in the set of selected golf hole locations in use; and determining the corresponding golf hole location score for that given potential golf hole location based on the received user scores.

In some examples, the method may include, for each physical golf green in the plurality of golf greens, repeating the process of receiving a plurality of user scores and determining the corresponding golf hole location score for the plurality of potential golf hole locations identified for that physical golf green.

In some examples, the method may include determining the corresponding golf hole location score for the given potential golf hole location scores by: generating a plurality of normalized user scores by normalizing each received user score based on user specific data from the user; and determining the corresponding golf hole location score based on the plurality of normalized user scores.

In some examples, the method may include determining the corresponding golf hole location score for the given potential golf hole location scores by: generating a plurality of adjusted user scores by adjusted each received user score based on score timeframe data for the received user score; and determining the corresponding golf hole location score based on the plurality of adjusted user scores.

In accordance with a broad aspect, there is provided a computer program product comprising a non-transitory computer readable medium storing computer executable instructions for configuring a processor to perform a method of managing golf hole locations on a golf course, wherein the method is described herein.

In accordance with a broad aspect, there is provided a system for managing golf hole locations on a golf course, the system comprising: at least one processor; and a data storage unit; wherein the at least one processor is configured to perform a method of managing golf hole locations on a golf course, wherein the method is described herein.

It will be appreciated by a person skilled in the art that a device, method or computer program product disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

The drawings included herewith are for illustrating various examples of systems, methods, and devices of the teaching of the present specification and are not intended to limit the scope of what is taught in any way.

FIG. 1 shows a block diagram of an example system for managing a physical golf course.

FIG. 2 shows a block diagram of an example system for managing golf hole locations that may be used with the golf course management system of FIG. 1.

FIG. 3 is a flowchart illustrating an example process for managing golf hole locations.

FIG. 4 is a flowchart illustrating an example process for generating golf hole location scores.

FIG. 5 illustrates an example course management platform display showing a plurality of potential hole locations.

FIG. 6 illustrates an example course management platform display showing a score selection interface.

FIG. 7 illustrates an example course management platform display showing a plurality of selected golf hole locations.

FIG. 8 illustrates another example course management platform display showing a plurality of selected golf hole locations.

FIG. 9 illustrates another example course management platform display showing a plurality of selected golf hole locations.

### DESCRIPTION OF EXEMPLARY EMBODIMENTS

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

Embodiments described herein relate to management of golf courses. In particular, embodiments described herein may facilitate management of the golf greens of a golf course by identifying and guiding the positioning of golf hole locations for each golf green. Embodiments described herein may guide a course manager (or groundskeeper or other individual tasked with managing the greens) in cutting hole locations on the golf greens to increase user engagement while ensuring the greens remain in operational condition.

A golf course generally consists of a series of holes, typically 9 or 18 holes, although various courses may have different numbers of holes. The term “hole” generally refers to the part of the golf course associated with a particular teeing area, putting green and golf hole location. A golfer plays a hole beginning from the teeing area and ending when the ball is holed on the putting green.

Each hole has an associated golf green or putting green. Each hole also has an associated golf hole location on the corresponding green. As used herein, the term “golf hole location” refers to the actual position of a dug-out portion of the green in which a cup may be placed. A golfer completes a hole when the ball is putted (or otherwise hit) into the cup. Typically, a removable pin or flag is inserted into the cup to identify the golf hole location to golfers. The golf hole location for a given hole is typically selected for a specified timeframe (e.g. a day, two days, a week) and then moved to a different position on the green once the timeframe has ended.

From the perspective of a golf player, one of the main challenges during play is to score Par on a given hole. The term “Par” refers to the score that an expert player would be expected to make for a given hole under ordinary weather conditions, allowing two strokes on the putting green. This is often a challenging feat for players, not least because the golf hole location can change on a regular basis. Furthermore, although a hole is often associated with a specific par score (i.e. a specific level of difficulty), the actual difficulty of the hole can vary depending on the actual position of the golf hole location at a given time.

From the perspective of an individual tasked with managing and maintaining a golf course, it is important to ensure that the course remains in good condition throughout a golf season. To that end, it is important to manage regions of the course that may be prone to overuse and the resultant wear and tear. Since each player will inevitably walk on the green to complete a hole (even if only to remove the ball from the cup), management of the greens is crucial to ensure that the course remains playable throughout the season. This is particularly important because even slight disfiguration of the playing surface of a green can cause challenges when players are putting on the green.

Accordingly, embodiments described herein may facilitate the positioning of golf hole locations on the playing greens. Systems and methods described herein can be implemented to select golf hole locations and guide the cutting of those golf hole locations to facilitate careful and ongoing maintenance of golf greens. Systems and methods described herein may also maintain the engagement of golfers throughout the season, by ensuring that a desired level of challenging play is provided through the selected golf hole locations

In embodiments described herein, a course map of a golf course can be generated. The course map can include green map data representing the physical golf greens on the course. The green map data can provide, for each green, coordinate data that defines the perimeter of the green (i.e. green perimeter coordinate data).

For each green, potential golf hole locations can be identified within the perimeter of that green. The potential golf hole locations can be associated with golf hole location data that identifies the exact position of the potential golf hole location on the green. The golf hole location data may define the exact position of the golf hole location using absolute coordinate data (e.g. geolocation data such as GPS coordinates) and/or relative coordinate data (e.g. a location defined in relation to landmarks on the green such as the front of the green and the left or right side of the green).

User score data can be tracked for the course. User scores and related score data can be provided for the specific timeframes in which particular golf hole locations have been selected for the holes on the course. The user scores and related score data can then be used to determine an actual expected score for the potential golf hole locations that were in use in the relevant timeframe.

That is, a golf course may provide an expected score (i.e. Par) for each hole. However, the actual expected score for a given hole may vary depending on the golf hole location selected for a particular day. For example, although a scorecard may show a Par 5 for Hole #18 on a golf course, embodiments described herein may be used to determine that Hole #18 has an actual expected score of 4.25 for a first potential golf hole location, an actual expected score of 4.8 for a second potential golf hole location, an actual expected score of 5.5 for a third potential golf hole location, and so forth. The monitoring and analysis of user scores and related user score data can be repeated over an extended period (and, in some cases, on an ongoing basis) to determine actual expected scores for some or all of the potential golf hole locations on each hole.

Embodiments described herein may enable golf courses to arrange the golf hole locations on the golf course to provide one or more desired overall scores for the course. For example, a course manager may specify a desired overall score for a timeframe (e.g. a day) or a series of desired overall scores for a sequence of timeframes (e.g. the sequence of days in a week). Embodiments described herein can be configured to automatically identify and guide the positioning of golf hole locations for all of the holes of the golf course that provide an actual expected score(s) corresponding to the desired overall score.

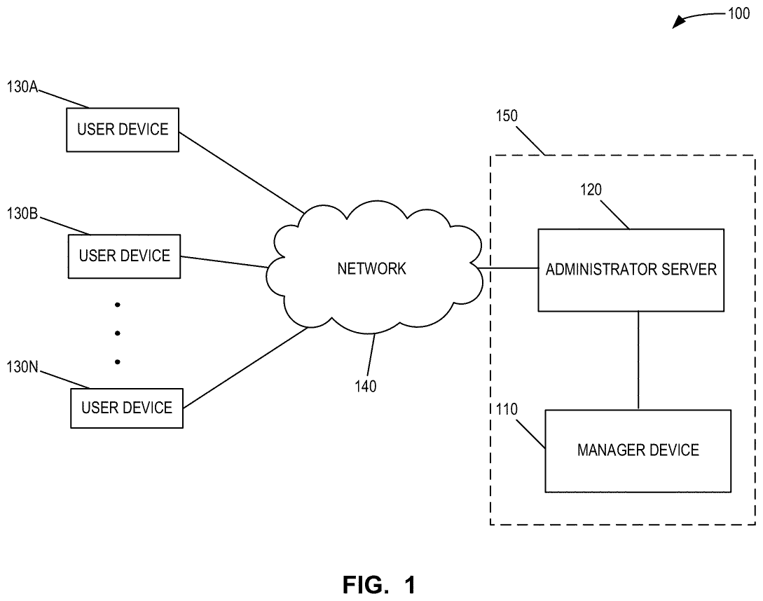

Referring now to FIG. 1, shown therein is a block diagram of a golf course management system 100 in accordance with an example embodiment.

Computer network system 100 generally comprises a plurality of computers connected via data communication network 140, which itself may be connected to the Internet. In general, however, the computer network system includes a manager device 110, an administrator server 120, and optionally a plurality of user devices 130A-130N (which may also be referred to as golfer devices) connected via network 140. In the example system 100 illustrated, the manager device 110 and administrator server 120 may be collectively referred to as a course management system 150.

Typically, the connection between network 140 and the Internet may be made via a firewall server (not shown). In some cases, there may be multiple links or firewalls, or both, between network 140 and the Internet. Some organizations may operate multiple networks 140 or virtual networks 140, which can be internetworked or isolated. These have been omitted for ease of illustration, however it will be understood that the teachings herein can be applied to such systems. Network 140 may be constructed from one or more computer network technologies, such as IEEE 802.3 (Ethernet), IEEE 802.11 and similar technologies.

Computers and computing devices may be connected to network 140 or a portion thereof via suitable network interfaces. Computing devices may also encompass any connected or “smart” devices capable of data communication, such as refrigerators, thermostats, industrial equipment and the like. Increasingly, this encompasses a wide variety of devices as more devices become networked through the “Internet of Things”. In some cases, one or more of the computing devices such as the user devices 130 may connect to network 140 via the Internet.

Examples of computers include the manager device 110, such as a such as a desktop, laptop, smartphone or tablet computer, which can connect to network 140 via a wireless connection or a wired Ethernet connection. The manager device 110 may also connect to the network 140 via the Internet. Manager device 110 has a processor, volatile memory and non-volatile storage memory, at least one network interface, input devices such as a keyboard and/or touchscreen, output devices such as a display and speakers, and may include various other input/output devices as will be appreciated. Manager device 110 may be portable.

Similarly, user devices 130 generally refer to a computing device, such as a desktop, laptop, smartphone or tablet computer, however user devices 130 may also include a wide variety of “smart” devices capable of data communication. Like computer 110, user device 130 has a processor, volatile and non-volatile memory, at least one network interface, and input/output devices. User device 130 may be portable, and may at times be connected to network 140 or a portion thereof.

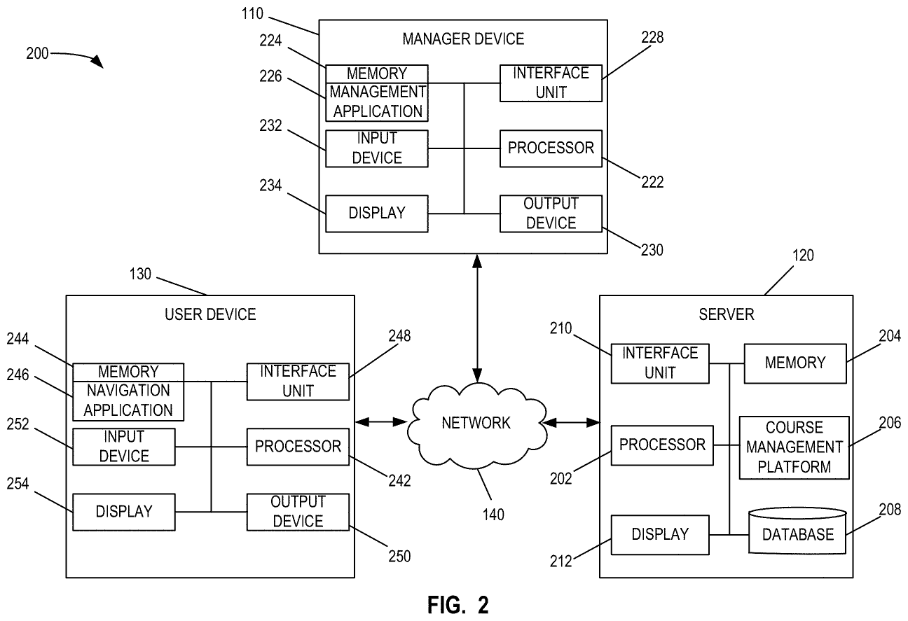

Administrator server 120 is a computer server that is connected to network 140. Like computing devices 110 and 130, server 120 has a processor, volatile and non-volatile memory, at least one network interface, and may have various other input/output devices. As with all devices shown in computer network system 100, there may be multiple servers 120, although not all are shown. The manager device 110, administrator server 120 and user device 130 are described in greater detail with reference to FIG. 2 below.

Each of the computers and computing devices may at times connect to external computers or servers via the Internet. For example, manager device 110 may connect to a software update server to obtain the latest version of a software application or firmware.

Server 120 may be configured to provide a golf course management platform. The golf course management platform may be remotely accessible to manager device 110 over network 140. For example, a user of manager device 110 may access the golf course management platform to assist in performing various tasks related to maintenance and management of the golf course and individual holes. For example, the golf course management platform may assist a user of the manager device 110 in selecting golf hole locations. In some cases, golf course management platform may automatically select the golf hole locations for the user. Golf course management platform may also assist a user of the manager device 110 in identifying the correct positioning of the selected golf hole locations on each golf green to enable the golf green to be cut accurately at the selected golf hole location.

A user of the manager device 110 may access the course management platform through a platform-specific application by operating a browsing application on the manager device 110 and navigating to the corresponding website to access the golf course management platform.

Alternately or in addition, the server 120 may provide a golf course management platform that is accessible through a course management application deployed on, or otherwise operable by, the manager device 110. A user may then operate the course management application on the manager device 110 to interact with the golf course management platform.

As used herein, the term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled.

The software application may be associated with an application identifier that uniquely identifies that software application. In some cases, the application identifier may also identify the version and build of the software application. A software application may be recognized by a name by both the people who use it, and those that supply or maintain it. Mobile applications or “apps” generally refers to software applications for installation and use on mobile devices such as smartphones and tablets or other “smart” devices.

Optionally, the server 120 may also include a golf course navigation platform accessible to user devices 130. The golf course navigation platform may be accessible through an installed application or over the Internet by accessing a website associated with the golf course management platform. For instance, a golfer may operate a browsing application on the user device 130 and navigate to the corresponding website to access the golf course navigation platform.

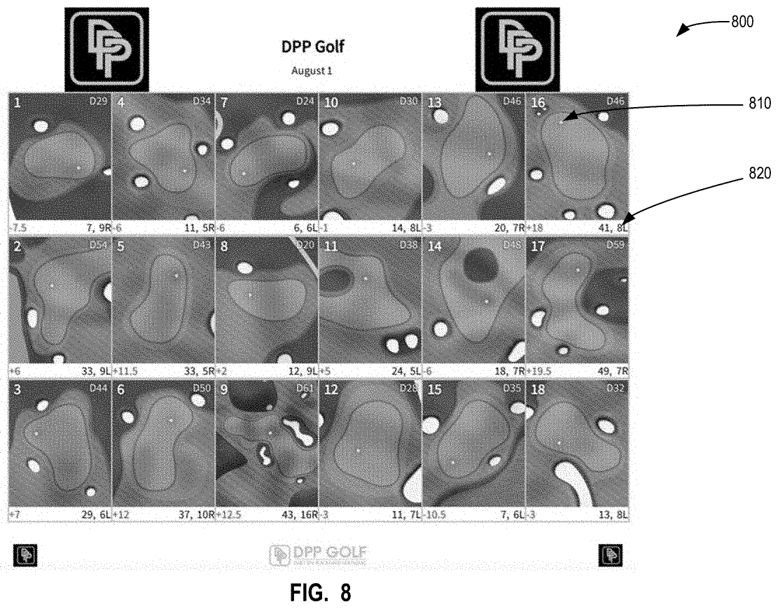

The golf course navigation platform may provide golfers with various displays and data related to the golf course and individual holes. For instance, the golf course navigation platform may provide a user of device 130 with data relating to the layout of the golf course and individual holes. The golf course navigation platform may interface with the golf course management platform to ensure that the layout data provided to the user device 130 is updated with accurate golf hole location data for a given day. For example, a golf course navigation platform GUI, such as GUI 800 shown in FIG. 8 described herein below, may be displayed on user device 130 to illustrate to the golfer the selected golf hole location currently in use. In some examples, the golf course navigation platform GUI may also display the actual expected score for the selected golf hole location currently in use, which may provide the user with greater insight regarding how to approach the hole on the day.

Referring now to FIG. 2, there is shown a block diagram of hole location management system 200 in accordance with an example embodiment. In the example illustrated, hole location management system 200 is constructed from manager device 110, an administrator server 120 and at least one user device 130. In some cases, the user device 130 may be omitted from golf hole location management system 200. In some cases, the administrator server 120 and device 110 (or the operations described as being performed by administrator server 120 and device 110) may be integrated or co-located.

Server 120 may be directly linked to manager device 110, for example, via a Universal Serial Bus, Bluetooth™ or Ethernet connection. Alternatively, administrator server 120 may be linked to manager device 110 via network 140 or, in some cases, the Internet. Administrator server 120 may also be linked to user devices 130 via network 140 or, in some cases, the Internet.

Administrator server 120 has a processor 202, a memory 204, a communication interface 210, a display 212 and a database 208. Although shown as separate elements, it will be understood that database 208 may be stored in memory 204.

Processor 202 is a computer processor, such as a general purpose microprocessor. In some other cases, processor 202 may be a field programmable gate array, application specific integrated circuit, microcontroller, or other suitable computer processor.

Processor 202 is also coupled to display 212, which is a suitable display for outputting information and data as needed by various computer programs. In particular, display 212 may display a graphical user interface (GUI). In some cases, the display 212 may be omitted from administrator server 120, for instance where the administrator server 120 is configured to operate autonomously to support a golf course management platform. In such cases, the administrator server 120 may be configurable using a computer such as the manager device 110 that is connected to the administrator server 120. Administrator server 120 may execute an operating system, such as Windows Server, MAC OS X Server, a GNU/Linux server operating system, or other suitable operating system.

The interface unit 210 may be any interface that allows the server 120 to communicate with other devices or computers. For example, communication interface 210 may include one or more data network interface, such as an IEEE 802.3 or IEEE 802.11 interface, for communication over a network. Interface unit 210 may include at least one of a serial port, a parallel port or a USB port that provides USB connectivity. Optionally, communication interface 210 may include a wireless unit such as a radio that communicates utilizing CDMA, GSM, GPRS or Bluetooth protocol according to standards such as IEEE 802.11a, 802.11b, 802.11g, or 802.11n. The wireless unit can be used to communicate with other devices or computers, such as manager device 110 and/or user device 130.

Processor 202 is coupled, via a computer data bus, to memory 204. Memory 204 may include both volatile and non-volatile memory. Non-volatile memory stores computer programs consisting of computer-executable instructions, which may be loaded into volatile memory for execution by processor 202 as needed. It will be understood by those of skill in the art that references herein to administrator server 120 as carrying out a function or acting in a particular way imply that processor 202 is executing instructions (e.g., a software program) stored in memory 204 and possibly transmitting or receiving inputs and outputs via one or more interface. Memory 204 may also store data input to, or output from, processor 202 in the course of executing the computer-executable instructions.

The memory 204 on administrator server 120 may store a software application referred to herein as a course management application 206. Although shown as separate elements, it will be understood that course management application 206 may be stored in memory 204.

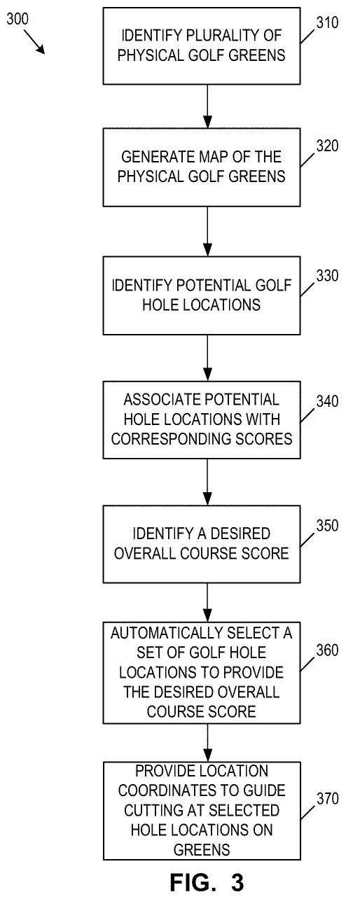

The course management application 206 may be configured to support a golf course management platform accessible by a device such as manager device 110. The golf course management platform may include an interactive platform interface in which the various holes of a physical golf course are presented. A user may interact with the platform interface using the manager device 110 in order to identify golf hole locations on the greens of a golf course. The user of the manager device 110 may also interact with the platform interface to perform various operations, such as mapping golf greens, setting a desired overall score, selecting golf hole locations and/or guiding the cutting of the greens at selected golf hole locations for example. An example process for positioning golf hole locations that may be implemented using the course management application 206 is described in further detail herein below with reference to FIG. 3.

The course management application 206 is presented primarily for ease of exposition, and it should be understood that the features and operations described in association with the administrator server 120 and/or course management application 206 may be performed using a plurality of software applications. Similarly, the features and operations described in association with the administrator server 120 may be distributed across multiple administrator servers and/or other administrator processors.

As noted above, memory 204 may also store database 208. In some example embodiments, database 208 is a relational database. In other embodiments, database 208 may be a non-relational database, such as a key-value database, a NoSQL database (e.g. using MongoDB), or the like.

The database 208 can store various data and information associated with a golf course. For example, database 208 may store course map data for the golf course. The course map data may identify the locations of greens within the course.

The course map data may include a plurality of green maps corresponding to the golf greens of the golf course. The green maps may include various green location data associated with each green, such as the location of the greens within the golf course and the perimeter each. The course management application 206 may access the course map data when identifying potential golf hole locations for the golf course.

The database 208 can also store location score data for potential golf hole locations. The location score data may specify an expected score (e.g. an expected Par score) for a particular golf hole location on the golf green. The course management application 206 may access the location score data when selecting golf hole locations for the golf course for a specified timeframe.

The database 208 can also store user score data for potential golf hole locations on the golf greens. For example, user scores achieved by players playing the holes may be collected through user devices 130. Additional score related data related to the received user scores, such as the score timeframe, timeframe data (e.g. weather data such as wind and/or rain, tee box location, course condition data such as wet conditions and/or fast conditions), user specific data (e.g. player handicap), and shot data (e.g. position measurements, distance measurements, and similar shot-related information) may also be collected, e.g. through user devices 130. The course management application 206 may access and analyze the user score data and score related data when determining the location score for a given potential golf hole location.

The course management application 206 can also interact with a navigation application 246 on user device 130 to collect user score data and score related data. This user score data can be transmitted to be stored database 208 (e.g. using mongo+node.js) for later retrieval by course management application 206 and/or management application 226 and/or navigation application 246 (e.g. through a custom app or a webpage).

Alternately or in addition, user score data and/or score related data may be acquired from external applications (e.g. alternate golf apps operating on user device 130).

Alternately or in addition, user score data and/or score related data may be acquired from a manager device 110, for instance where a golfer inputs user score data and user specific data (or information usable to determine the user specific data) into the manager device 110 at the end of a round of golf. For example, a user may provide demographic data to the manager device 110 that is usable to identify their handicap.

In some examples, score related data may be determined by the course management platform after receiving the user score data. For example, administrator server 120 may determine the timeframe data in response to receiving the user score data for a particular timeframe. Administrator server 120 may interface with various external data sources (e.g. weather applications) and/or devices (e.g. weather monitoring devices installed at the course) to determine timeframe data.

Alternately or in addition, timeframe data may be input through manager device 110. Course conditions for a particular timeframe may be evaluated by a user of the manager device 110. For example, a stimpmeter reading may be used to evaluate the conditions of the greens for the timeframe. The results of the stimpmeter reading may be input through management application 206 and used as timeframe data.

Similarly, tee box location data may be input through manager device 110. Variations in the tee box location may impact the distance from the tee to the hole location, resulting in changes to the difficulty of the hole. The tee box location data may then be stored in database 208 along with the associated tee box location timeframe to account for such variations.

User device 130 is generally a computing device usable by a user such as a golfer. For example, user device 130 may be a desktop computer, laptop computer or a mobile computer such as a smartphone or tablet or other “smart” device that may be networked through the “Internet of Things”. User device 130 has a processor 242, a communication interface 248 for data communication with communication interfaces 210 and 228, a display 254 for displaying a golf course navigation platform GUI (such as GUI 800 shown in FIG. 8 described herein below), and a memory 244 that may include both volatile and non-volatile elements. Display device 254 may include any type of device for presenting visual information. For instance, the display 254 may be a cathode ray tube, a flat-screen monitor and the like if the user device 130 is a desktop computer. In other cases, the display 254 may be a display suitable for a laptop, tablet or handheld device such as an LCD-based display and the like.

The user device 130 also includes at least one input device 252 (e.g. a pushbutton keyboard, mouse, camera, touchscreen, biometric reader and the like), and may include at least one output device 250 (e.g. a printer, a wireless radio, a speaker and the like). As with administrator server 120, references to acts or functions by user device 130 imply that processor 242 is executing computer-executable instructions (e.g., a software program) stored in memory 244.

For instance, navigation application 246 may be stored on the user device 130. Although shown separately from memory 244, it will be understood that navigation application 246 may be stored in memory 244. The navigation application 246 may communicate with the navigation platform provided by the course management application 206 of administrator server 120 to access and review data associated with the golf course and/or to provide user score data to the course management application 206.

In some examples, navigation application 246 may provide a user with hole-specific data for a particular hole on the golf course. For example, navigation application 246 may interface with the navigation platform provided by the course management application 206 to determine the current golf hole location. Navigation application 246 may then provide the user with a hole location GUI, such as GUI 800 described herein below.

In some cases, a user may be provided with a golf hole location identifier and can input the golf hole location identifier to navigation application 246 to determine the exact position of the current golf hole location on the green. Alternately or in addition, navigation application 246 may receive the coordinates of the exact position of the current golf hole location on the green automatically from the navigation platform. Navigation application 246 may then provide the user with hole-specific data that is tailored to the current golf hole location.

In some examples, navigation application 246 may also provide the user with location score data associated with the selected golf hole location currently in use. For example, navigation application 246 may indicate that an expected score for the currently selected golf hole location is a 4 whereas an expected score for the hole more generally is a 3.5. This may provide the user with information usable to adjust their strategy when playing the hole given the selected golf hole location currently in use.

In some embodiments, the navigation application 246 may be a dedicated application, such as a downloadable mobile application provided by the administrator server 120. A user of the user device 130 may download the navigation application 246 from administrator server 120 or through an app store such as the Apple App Store or Google Play. In some other embodiments, the navigation application 246 may be a web browser application on the user device 130, which can be used to navigate to a website hosting the course navigation platform interface.

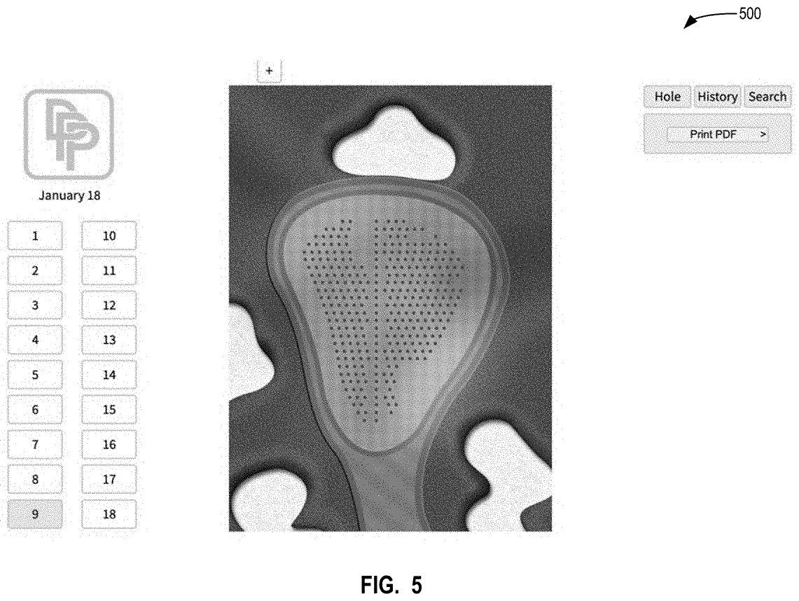

Manager device 110 is generally a computer similar to server 120 and user device 130. The manager device 110 has a processor 222, a communication interface 228 for data communication with communication interfaces 210 and 248, a display 234 for displaying a golf course management GUI (such as GUIs 500-700 shown in FIGS. 5-7 described herein below), and a memory 224 that may include both volatile and non-volatile elements.

The manager device 110 also includes at least one input device 232 (e.g. a pushbutton keyboard, mouse, camera, touchscreen, biometric reader and the like), and may include at least one output device 230 (e.g. a printer, a wireless radio, a speaker and the like). As with administrator server 120 and user device 130, references to acts or functions by manager device 110 imply that processor 222 is executing computer-executable instructions (e.g., a software program) stored in memory 224.

A management application 226 may be stored on the manager device 110. Although shown separately from memory 224, it will be understood that management application 226 may be stored in memory 224. The management application 226 may communicate with the course management application 206 of administrator server 120 to identify golf hole locations, determine desired course scores, guide the cutting of selected golf hole locations and so forth.

Although the management application 226 is shown as installed on manager device 110, the management application 226 may be otherwise accessible to the manager device 110 for instance as a cloud application accessible to the manager device 110 over a network such as the Internet. An example process of positioning golf hole locations that may be implemented using the management application 226 is described in further detail herein below with reference to FIG. 3.

The manager device 110, administrator server 120 and user device 130 may have various additional components not shown in FIG. 2. For example, additional input or output devices (e.g., keyboard, pointing device, etc.) may be included beyond those shown in FIG. 2.

In the description that follows devices such as user device 130, administrator server 120 and/or manager device 110 are described performing certain acts. It will be appreciated that any one or more of these devices may perform an act automatically or in response to an interaction by a user of that device. For example, the user of the device 130 may manipulate one or more input devices 252 (e.g. a touchscreen, a mouse, or a button) causing the device 130 to perform the described act. In many cases, this aspect may not be described below, but it will be understood.

Referring now to FIG. 3, shown therein is a flowchart of an example process 300 for managing golf hole locations on a physical golf course. Process 300 is an example golf hole location management process that can be implemented by system 100 and/or system 200. In general, process 300 may be implemented by at least one processor such as administrator server 120 providing a course management platform accessible to a manager device 110.

At 310, a plurality of physical golf greens can be identified. The plurality of physical golf greens can include the greens associated with a particular golf course.

For example, a user of manager device 110 may identify the plurality of physical golf greens associated with the golf course through management application 226. Alternately or in addition, administrator server 120 may identify the plurality of physical golf greens by interfacing with external data sources, such as an existing golf course website. A user of manager device 110 may identify a golf course through management application 226 and administrator server 120 may connect to related data sources to identify the plurality of physical golf greens associated with the golf course.

At 320, a map of the plurality of physical golf greens can be generated. The map of the plurality of physical golf greens for a golf course may be referred to as a course map. The course map can define, for each physical golf green, a perimeter of that physical golf green. The course map can include coordinate data that defines the perimeter of the green (i.e. green perimeter coordinate data).

For example, for each of the physical golf greens identified at 310, a green image (i.e. an image of that physical golf green) can be retrieved from an imaging data source such as a satellite image database (e.g. Google maps). The shape and dimensions of each physical golf green can be determined from the green image, and in some cases associated geolocation coordinate data. For example, geolocation coordinate data associated with retrieved satellite images may be used to generate the course map.

In some examples, green geolocation coordinate data may be retrieved from the same data source as the green image. Alternately or in addition, green geolocation coordinate data can be retrieved from alternate data sources, such as data sources that store geolocation coordinate data specific to golf courses. Optionally, the green geolocation coordinate data may be correlated with retrieved green image data in order to generate the course map.

In some examples, the manager device 110 may be used to acquire green location coordinate data associated with the plurality of physical golf greens. The green location coordinate data can include geolocation coordinate data captured by the manager device 110. For example, a user of manager device 110 may operate the management application 226 while navigating the plurality of physical golf greens in order to generate the green location coordinate data. The course map of the plurality of physical golf greens can be generated using the generated green location coordinate data.

At 330, a plurality of potential golf hole locations can be identified for each physical golf green. Each potential golf hole location can be associated with corresponding golf hole location data. The golf hole location data corresponding to each potential golf hole location can specify golf hole location coordinates for that potential golf hole location within the perimeter of the corresponding physical golf green.

Administrator server 120 can be configured to analyze the course map generated at 320 to identify the plurality of potential golf hole locations for each physical golf green. Administrator server 120 can be configured to define an initial set of potential golf hole location for each physical golf green based on the shape and dimensions of the physical golf green.

For example, course management application 206 may specify a boundary spacing threshold for each potential golf hole location. The boundary spacing threshold may require each potential golf hole location to be spaced from the perimeter of the green by at least a minimum boundary distance (e.g. one foot, two feet). In some cases, the boundary spacing threshold may be defined automatically (e.g. as a standard boundary spacing amount). Alternately or in addition, a user of manager device 110 may define, or adjust, the boundary spacing threshold using management application 226.

Course management application 206 can also define a location spacing threshold for the plurality of potential golf hole locations. The location spacing threshold may require each potential golf hole location to be spaced apart from every other potential hole location by at least a minimum location distance (e.g. six inches). In some cases, the location spacing threshold may be defined automatically (e.g. as a standard location spacing amount). Alternately or in addition, a user of manager device 110 may define, or adjust, the location spacing threshold using management application 226.

Course management application 206 can be configured to define the initial set of potential hole locations based on the defined spacing thresholds. In some cases, the plurality of potential golf hole locations can be defined to include all of the potential hole locations in the initial set of potential hole locations. Alternately or in addition, the plurality of potential golf hole locations can be defined to include a subset of the potential hole locations in the initial set of potential hole locations.

For example, one or more hole locations in the initial set of potential hole locations may be omitted from the plurality of potential golf hole locations. For example, hole locations in the initial set of potential hole locations may be omitted from the plurality of potential golf hole locations based on the topography at that hole location (e.g. the slope of the green at that hole location). The hole locations may be omitted automatically by course management application 206 using the green location data. Alternately or in addition, hole locations may be omitted by a user of manager device 110 through the management application 226.

In some cases, the golf hole location coordinates for each potential golf hole location can be defined as an absolute geolocation coordinate. For example, the golf hole location coordinates may be generated based on green location data acquired from the manager device 110 (e.g. as GPS coordinates).

Alternatively or in addition, golf hole location coordinates may be defined relative to the physical golf green on which the potential golf hole location is positioned. The golf hole location coordinates may be defined relative to specified boundaries of the green or other landmarks of the green. The golf hole location coordinates may be defined relative to the boundary of the green (e.g. the frontmost limit of the corresponding green and the leftmost or rightmost side of the green). For example, GUI 700 illustrates a set of selected golf hole locations each having associated relative golf hole coordinates. The selected golf hole location 710 for Hole 8 is identified using the relative coordinates 720 (30, 9 L) and the relative spacing 730 from the center of the green (+9.5). The exact position of the selected golf hole location can be identified at 30 yards from the front of the green and then 9 yards from the left. Similar relative golf hole coordinates are shown for each hole in GUI 700.

Each potential golf hole location may be associated with a unique location identifier (e.g. a golf hole location name or number). The golf hole location coordinates for that potential hole location can then be associated with the corresponding unique location identifier.

The unique location identifier can be stored in database 208 along with the associated golf hole location coordinates. The manager device 110 and/or server 120 may use the unique location identifiers to track the use of golf hole locations over time. The unique location identifiers may also be associated with related data, such as user score data, generated when the corresponding golf hole location is in use.

At 340, each potential golf hole location can be associated with a corresponding golf hole location score. The corresponding golf hole location score may represent an actual expected score for the hole when that potential golf hole location is in use.

The golf hole location scores can be determined based on data received from users playing the golf course. For example, administrator server 120 may collect user score data associated with each potential golf hole location. This user score data can then be analyzed to determine the corresponding golf hole location score.

As a most basic example, user scores collected for a particular potential golf hole location from a plurality of user devices 130 may be averaged to identify the corresponding golf hole location score. For instance, although the hole may be identified as being a Par 5, the average score for a first potential golf hole location may be 4.25 while the average score for a second potential golf hole location may be 5.5. The corresponding golf hole location score for the first potential golf hole location may then be identified as 4.25 while the corresponding golf hole location score for the second potential golf hole location may then be identified as 5.5. This process may then be repeated over an extended period of time (in some cases on an ongoing basis) to identify the corresponding golf hole location score for each potential golf hole location.

Course management application 206 may also collect additional score related data in association with the received user scores. The score related data may be used to normalize and/or adjust the received user scores to account for additional factors (e.g. user specific data such as skill/handicap, timeframe data such as weather and/or tee box location, etc.) beyond changes in the hole location.

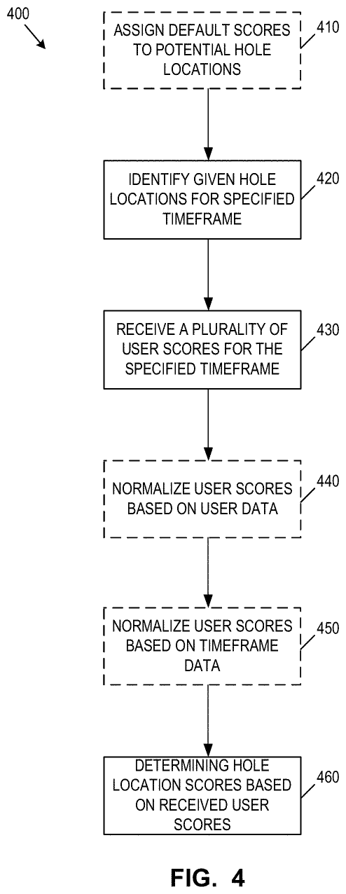

An example process for determining golf hole location scores is described in further detail herein below with reference to FIG. 4.

At 350, at least one overall course score can be identified for the golf course. For instance, a user may input a desired overall course score through the manager device 110. The desired overall course score may represent a score, or difficulty level, that the user wants to have the course provide for a specified timeframe (e.g. a day). For example, the user may input a specific score (e.g. 73) or a difficulty level (e.g. easy) through manager application 206.

In some cases, a plurality of overall course scores may be identified for the golf course. The plurality of overall course scores may be selected for a sequence of specified time frames (e.g. seven overall course scores selected for each day of a week).

At 360, at least one set of golf hole locations can be selected for the golf course based on the at least one overall course score identified at 350. Each set of golf hole locations can include a plurality of selected golf hole locations. The plurality of selected golf hole locations for each set of golf hole locations can include one selected golf hole location for each physical golf green. The plurality of selected golf hole locations for each set of golf hole locations can be selected such that a sum of the corresponding golf hole location scores correspond to the particular overall course score for that set of golf hole locations. That is, the plurality of selected golf hole locations for a set of golf hole locations can be determined by identifying potential golf locations that provide, in sum, an expected score equal, or near to, the desired overall course score.

Each set of golf hole locations can correspond to a particular overall course score in the at least one overall course score. When only a single overall course score is determined at 350, a corresponding set of golf hole locations can be identified.

As noted above at 350, however, the at least one overall course score may include a plurality of overall course scores. Accordingly, a plurality of sets of golf hole locations may be selected to correspond to the plurality of overall course scores. Each set of golf hole locations in the plurality of sets of golf hole locations may correspond to a particular one of the overall course scores identified at 350. That is, each set of golf hole locations can correspond to one of the specified time frames in the sequence of specified time frames for the plurality of overall course scores.

In some cases, the set of golf hole locations may be selected automatically by course management application 206. For example, course management application 206 may identify a set of golf hole locations that includes one hole location on each hole and whose hole location scores, when summed, are closest to the desired overall score.

In some cases, course management application 206 may identify a plurality of potential sets of golf hole locations. For instance, each potential set of golf hole locations may include hole locations whose hole location scores, when summed, are within an acceptable score distance from the desired overall score (e.g. +/−0.1, +/−0.25, +/−0.5 etc.). The set of golf hole locations may then be selected from amongst those potential sets of golf hole locations. In some cases, the acceptable score distance may be defined automatically by course management application 206 (e.g. as a default value). Alternately or in addition, a user of manager device 110 may define the acceptable score distance using the management application 226.

In some cases, the set of golf hole locations may be selected from the potential sets of golf hole locations randomly. Alternately, further criteria may be applied to determine the set of golf hole locations to select.

For example, a minimum spacing criteria may be defined for the set of golf hole locations. The minimum spacing criteria may specify that each selected golf hole location in the selected set of golf hole locations be spaced apart from the previous hole location on that hole by a minimum distance value. The minimum distance value may be an absolute value (e.g. 10 yards, 15 yards etc.) or a relative value (e.g. 10% of the length of the green, 15% of the length of the green etc.). In some cases, the minimum distance value may be defined automatically (e.g. as a standard minimum distance value). Alternately or in addition, a user of manager device 110 may define, or adjust, the minimum distance value using management application 226.

The set of golf hole locations may be selected from the potential sets of golf hole locations by identifying a particular potential set of golf hole locations that satisfies the minimum spacing criteria for each hole. For instance, the set of golf hole locations may be selected by identifying the particular potential set of golf hole location that satisfies the minimum spacing criteria for the greatest number of preceding hole locations (e.g. for more than one previous hole location on each hole, for the last three hole locations on each hole etc.).

Alternately or in addition, the set of golf hole locations may be selected from the potential sets of golf hole locations to optimize a spacing between the selected golf hole locations and the hole locations used in a specified number of preceding time frames (e.g. the most recent timeframe, the two most recent timeframes, the three most recent timeframes etc.). In some cases, the optimization may further involve weighting the spacings between the selected hole locations and the most recent preceding hole locations more than spacings between the selected hole locations and earlier preceding hole locations.

Where multiple sets of golf hole locations are being selected, similar automatic selection methods may be applied to optimize the spacing between the selected hole locations while ensuring proximity to the desired overall courses.

Alternately or in addition, management application 226 may display a potential set of golf hole locations that can be accepted or declined by a user of manager device 110. The potential set of golf hole locations may provide the user of manager device 110 with multiple potential golf hole locations for a given hole that can result in the set of golf hole locations corresponding to the overall course score. In some cases, the automatic selection methods described above may be used to identify the potential sets of golf hole locations to display on manager device 110. The user of manager device 110 may then select the particular golf hole locations from the potential golf hole locations included in the potential set of golf hole locations.

In some examples, the manager device 110 may determine a plurality of available golf hole locations from the plurality of potential golf hole locations associated with a particular hole. The plurality of selected golf hole locations may then be selected from the plurality of available golf hole locations. In some cases, for a given physical golf green, the plurality of available golf hole locations may omit at least one of the potential golf hole locations for that physical golf green. For example, for a given physical golf green, the plurality of available golf hole locations may be determined by omitting potential golf hole locations previously used within a predefined timeframe. This may help ensure that wear and tear is more evenly distributed across the physical golf greens.

Course management application 206 may monitor the historical hole location data for each golf green. For example, the historical hole location data stored in database 208 can include previously used hole along with the in-use timeframe for those hole locations. The historical hole location data can then be used to identify the plurality of available golf hole locations.

In some cases, the plurality of available golf hole locations may be determined by automatically omitting any potential golf hole locations previously used within the predefined timeframe (e.g. one day, one week). The predefined timeframe may be specified by a user of manager device 110 and/or set as a default timeframe. In some cases, the predefined timeframe may be defined based on a specified number of previous hole locations (e.g. no potential hole location can be repeated until the specified number of previous hole locations has passed).

In some cases, the plurality of available golf hole locations may also omit potential golf hole locations adjacent to any potential golf hole locations previously used within the predefined timeframe. This may further help to space out the wear and tear on the green and allow proper recovery time for the regions of the green.

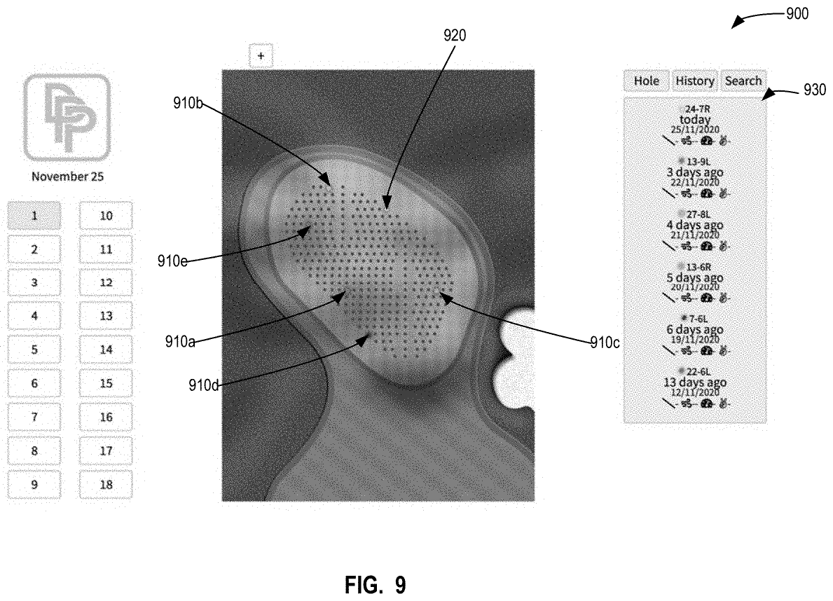

In some cases, management application 226 may be configured to display historical hole location data. GUI 900 shown in FIG. 9 illustrates an example of a green map display showing the historical hole location data for a particular hole. The historical hole location data may allow a user of manager device 110 to select, or modify, the selected golf hole locations to account for historical use of the green and/or additional factors such as the current conditions of the course.

In some cases, course management application 206 may monitor the historical hole location data over time for a course or a particular user of a manager device 110. Course management application 206 may evaluate the historical hole location data to identify any hole selection patterns and/or preferences for the course and/or the particular user. The course management application 206 may then use the identified patterns and/or preferences to select golf hole locations (e.g. where golf hole locations are equally suitable according to the particular scoring and/or optimization methods used, previously preferred hole locations may be selected ahead of other hole locations) and/or to identify potential golf hole locations to display to a user of manager device 110.

At 370, the cutting of golf holes on the plurality of physical golf greens can be guided through the manager device 110. For example, a set of golf hole location coordinates can be provided to the manager device 110 to guide the cutting of the hole on the green. The set of golf hole location coordinates can be defined by the golf hole location coordinates of the selected golf hole locations of a particular set of golf hole locations. GUI 800 shown in FIG. 8 illustrates an example of a course map display that includes the golf hole location coordinates for the selected golf hole locations. GUI 800 is an example of a graphical user interface that may be used to guide the cutting of the physical golf greens.

In some examples, the manager device 110 may be further configured to guide the cutting of the golf greens using absolute golf hole location coordinates. This may ensure that the greens are cut at the exact right position. This may also ensure that any variations on the hole location are detected and accounted for when evaluating scores collected for that hole.

In some cases, the geolocation data acquired by the manager device 110 may be insufficient on its own to ensure accuracy of the hole location. For instance, GPS coordinates for mobile applications may provide accuracy up to only +/−15 feet. Accordingly, manager device 110 can be configured to interface with a location correction device usable to determine the precise location of the hole location with much greater accuracy (e.g. to within +/−2 cm). The location correction device along with course management application 226 may thus guide the cutting of the hole locations with great precision. Additionally, the location correction device along with management application 226 can be used to accurately log the cut hole location to ensure that course management application 206 associates the received score data with the exact hole position.

In some cases, a standalone Global Navigation Satellite System (GNSS) receiver may be used as a location correction device to increase the location accuracy achievable by manager device 100. For example, a GCX3 GNSS receiver from SOKKIA may be used as the location correction device, although various other types of receivers may be used.

In some cases, the location correction device may interact with external data providers in order to provide accurate location data to the manager device 110. For instance, a GNSS receiver may be configured to interact with a GNSS correction service such as the Topnet Live service provided by TOPCON.

Referring now to FIG. 4, shown therein is a flowchart of an example process 400 for golf hole location scores. Process 400 is an example golf hole location scoring process that can be implemented by system 100 and/or system 200. Process 400 may be used, for example, in conjunction with process 300 described herein above for managing the position of golf hole locations. In general, process 400 may be implemented by at least one processor such as administrator server 120 providing a course management platform accessible to a manager device 110.

At 410, optionally each potential golf hole location may be assigned a default score. For example, each potential golf hole location may be assigned a score corresponding to the Par identified for the hole. The default score may then be modified, over time, based on data generated through process 400.

At 420, a given golf hole location can be determined for a particular timeframe. For example, a user of manager device 110 may input the selected golf hole location for the timeframe through manager application 226. Alternately or in addition, the given golf hole location may be determined using geolocation data from the manager device 110 (as described at 370 above).

At 430, a plurality of user scores can be received for a given golf hole location. Each user score can be received from a user of the golf course. For example, a user may input a score through navigation application 246. Each received user score can correspond to the particular timeframe from 420 in which that given potential golf hole location was included in the set of golf hole locations in use. Additional score related data related to the received user scores, such as the playing score timeframe, timeframe data (e.g. weather data such as wind and/or rain, tee box location, course condition data such as wet conditions and/or fast conditions), user specific data (e.g. player handicap), and shot data (e.g. position measurements, distance measurements, and similar shot-related information) may also be collected.

In some cases, additional user specific data may also be received from the user devices 130, e.g. through navigation application 246. For example, user specific data such as player handicap may be received from the user devices 130.

In some cases, additional timeframe data may also be associated with the user score data. For example, weather data such as wind and/or rain, tee box location, course condition data such as wet conditions and/or fast conditions and similar timeframe data may be identified by the user devices 130 and/or by the manager device 110 and/or by server 120.

At 440, optionally each received user score can be normalized based on the user specific data received from the user devices 110 to generate a plurality of normalized user scores. For example, handicap data corresponding to the user from whom the score data was received may be used to adjust the received user scores. The normalized user scores may be used in determining the corresponding golf hole location score at 460 herein below.

As a simplified example, the received user scores from a particular user can be normalized based on the player's handicap. For example, where the handicap data for a particular user is +9, the received user scores for that particular user on the 9 most difficult holes will be normalized by subtracting one stroke for each of these holes to determine the normalized user scores for that user.

At 450, optionally each received user score can be adjusted based on timeframe data to generate a plurality of adjusted user scores. For example, weather data, course condition data, tee box location data and the like corresponding to the timeframe in which the score data was generated may be used to adjust the received user scores. The adjusted user scores may be used in determining the corresponding golf hole location score at 460 herein below.

At 460, the corresponding golf hole location score for a given potential golf hole location can be determined based on the received user scores from 430. As noted above, the received user scores may be normalized (as at 440) and/or adjusted (as at 450) before being used to determine the golf hole location score. For example, an average of the received user scores (possibly adjusted and/or normalized) can be used to determine the golf hole location score.

In some cases, a plurality of golf hole location scores may be determined for each golf hole location. For example, the plurality of golf hole location scores for a given golf hole location may correspond to user specific data such as skill/handicap levels. For example, a first location score may be determined based on received user scores associated with user specific data indicating a handicap of 5 or less while a second location score may be determined based on received user scores associated with user specific data indicating a handicap of 6-10.

The plurality of golf hole location scores may together provide an overall golf hole location score for the golf hole location. However, the plurality of golf hole location scores may also enable a user of manager device 110 to identify golf hole locations for a particular timeframe based on hole location scores generated from a filtered subset of users.

For example, a user of manager device 110 may use the overall golf hole location scores when selecting the hole locations for a regular timeframe at the course. However, for timeframes in which events are occurring (e.g. tournaments), a selected golf hole location score from the plurality of golf hole location scores may result in golf hole locations more tailored to the course for that day. For instance, depending on the level of skill expected for the tournament (e.g. a youth tournament vs. a pro tournament) different selected golf hole location scores may be used to determine the golf hole locations (based on a filtered subset of users as described above).

The process of receiving a plurality of user scores and determining the corresponding golf hole location score can be repeated for each potential golf hole location identified for a physical golf green. This process may also be repeated across each physical golf green in the plurality of golf greens. This may provide an extensive course map with a plurality of potential golf hole locations on each physical green having corresponding golf hole location scores. This may further enable the process of positioning golf hole locations on an ongoing basis to ensure user engagement while protecting greens from uneven wear and tear.

Referring now to FIG. 5, shown therein is an example of an interactive course management platform display 500 in accordance with an embodiment. The display 500 is an example of a GUI that may be generated by a management application 226 operating on a manager device 110. Alternately, the GUI illustrated by display 500 may be generated by a browser operating on a manager device 110 when a user navigates to the course management platform provided by the server 120 using the manager device 110.

The interface 500 shown in FIG. 5 is an example of a green map display illustrating the plurality of potential hole locations for a particular hole (in this case, hole 9). The green map display shown in interface 500 illustrates the position of all the potential hole locations for the particular hole.

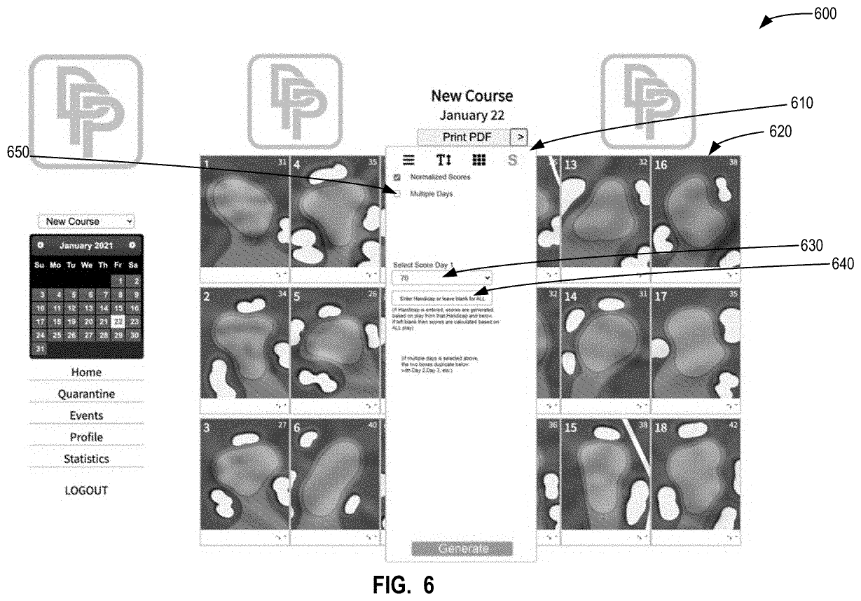

Referring now to FIG. 6, shown therein is an example of an interactive course management platform display 600 in accordance with an embodiment. The display 600 is an example of a GUI that may be generated by a management application 226 operating on a manager device 110. Alternately, the GUI illustrated by display 600 may be generated by a browser operating on a manager device 110 when a user navigates to the course management platform provided by the server 120 using the manager device 110.

The interface 600 shown in FIG. 6 is an example of a score selection interface 610 that may be provided to a user of manager device 110. As shown in display 600, the score selection interface 610 is overlaid on course map display 620.

The score selection interface 610 provides an example desired score input 630. A user of manager device 110 can use the desired score input 630 to define the desired overall course score for a particular timeframe, which in the example of interface 600 is identified as Day 1.

As shown in display 600, the score selection interface 610 can also include a score filtering input 640. The score filtering input 640 can be used by the user of manager device 110 to specify that the golf hole locations for the particular timeframe should be selected based on hole location scores generated from a filtered subset of users. The user of manager device 110 can specify the filtered subset of users through the score filtering input 640, for instance by specifying a range of handicaps to be used.

As shown in display 600, the score selection interface 610 can also include a multi-score input 650. A user of manager device 110 can select the multi-score input 650 to specify that desired score inputs are being provided for a sequence of timeframes (multiple days in the example of display 600).

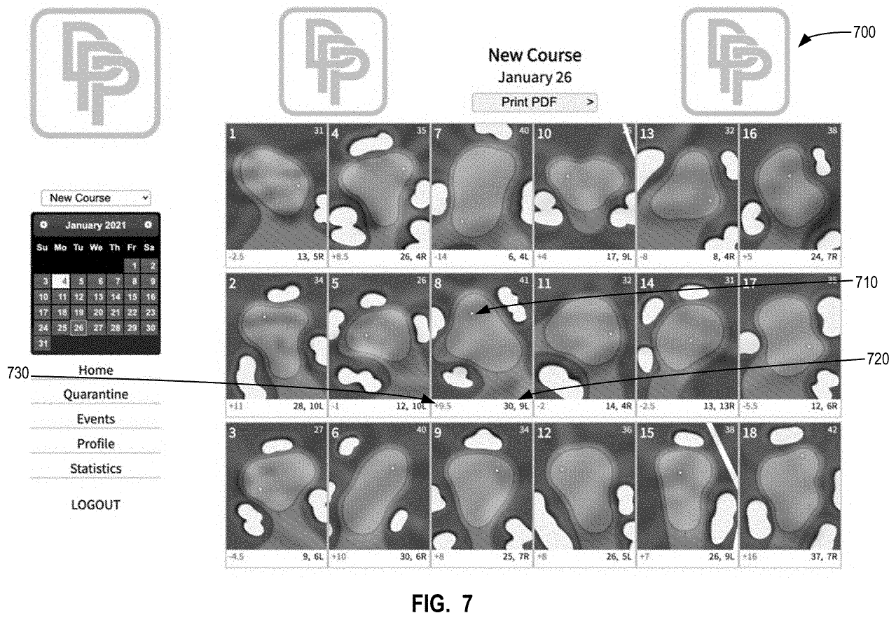

Referring now to FIG. 7, shown therein is an example of an interactive course management platform display 700 in accordance with an embodiment. The display 700 is an example of a GUI that may be generated by a management application 226 operating on a manager device 110. Alternately, the GUI illustrated by display 700 may be generated by a browser operating on a manager device 110 when a user navigates to the course management platform provided by the server 120 using the manager device 110.

The interface 700 shown in FIG. 7 is an example of a course map display illustrating the plurality of physical golf greens for a golf course. As shown in interface 700, the selected golf hole locations 710 for each green are shown graphically on the corresponding green map. Additionally, relative coordinates 720 are provided for each selected golf hole location.

In the example of interface 700, the selected golf hole location 710 for Hole 8 is identified using the relative coordinates 720 (30, 9 L) and the relative spacing 730 from the center of the green (+9.5). The exact position of the selected golf hole location 710 can be identified at 30 yards from the front of the green and then 9 yards from the left. Similar relative golf hole coordinates are shown for each hole in GUI 700.

Referring now to FIG. 8, shown therein is another example of an interactive course management platform display 800 in accordance with an embodiment. The display 800 is an example of a GUI that may be generated by a management application 226 operating on a manager device 110. Alternately, the GUI illustrated by display 800 may be generated by a browser operating on a manager device 110 when a user navigates to the course management platform provided by the server 120 using the manager device 110.

The interface 800 shown in FIG. 8 is another example of a course map display illustrating the plurality of physical golf greens for a golf course. As shown in interface 800, the selected golf hole locations 810 for each green are shown graphically on the corresponding green map. Additionally, relative coordinates 820 are provided for each selected golf hole location. Interface 800 is an example of a course map display that may be shown to a user of manager device 110 when guiding the cutting of hole locations on the physical golf greens.

Optionally, interface 800 may also be an example of a GUI that may be generated by a navigation application 246 operating on a user device 130. Interface 800 is an example of a course map display that may be shown to a user of user device 130 to indicate the position of the selected golf hole location 810 currently in use.

Referring now to FIG. 9, shown therein is another example of an interactive course management platform display 900 in accordance with an embodiment. The display 900 is an example of a GUI that may be generated by a management application 226 operating on a manager device 110. Alternately, the GUI illustrated by display 900 may be generated by a browser operating on a manager device 110 when a user navigates to the course management platform provided by the server 120 using the manager device 110.

The interface 900 shown in FIG. 9 is an example of a green map display illustrating the plurality of potential hole locations for a particular hole. The green map display shown in interface 900 illustrates the position of all the potential hole locations for the particular hole. The green map display shown in interface 900 also illustrates historical hole location data for the particular hole. In particular, interface 900 provides a graphical display of the previously-used golf hole locations (910a-910e) for a series of historical timeframes. This historical hole location data may assist a user of manager device in selecting the particular hole location 920 for the particular hole for a current (or future) timeframe. As shown in display 900, a legend 930 may also be shown that includes the relative coordinates for each of the previously-used golf hole locations 910 (as well as the currently selected hole location 920).

As will be apparent to a person of skill in the art, certain adaptations and modifications of the described methods can be made, and the above discussed embodiments of key management processes should be considered to be illustrative and not restrictive.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. In other instances, well-known methods, procedures and components have not been described in detail so as not to obscure the description of the embodiments. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

We claim:

1. A method of managing golf hole locations on a golf course, the method comprising:
identifying a plurality of physical golf greens associated with the golf course;
generating a map of the plurality of physical golf greens, wherein the map defines, for each physical golf green, a perimeter of that physical golf green;
for each physical golf green:
identifying a plurality of potential golf hole locations, wherein each potential golf hole location is associated with corresponding golf hole location data, wherein the golf hole location data corresponding to each potential golf hole location specifies golf hole location coordinates for that potential golf hole location within the perimeter of the corresponding physical golf green;
associating each potential golf hole location with a corresponding golf hole location score, wherein, for each potential golf hole location, the corresponding golf hole location score is determined based on user scores received from a plurality of user devices while that potential golf hole location is in use;
determining a plurality of available golf hole locations from the plurality of potential golf hole locations associated with that physical golf green by:
identifying a plurality of recently used golf hole locations in the plurality of potential golf hole locations; and
defining the plurality of available golf hole locations to include an available subset of the potential golf hole locations in the plurality of potential golf hole locations, wherein the available subset of the potential golf hole locations omits the plurality of recently used golf hole locations;
identifying a desired overall course score for the golf course;
selecting a set of selected golf hole locations, wherein the set of selected golf hole locations comprises a plurality of selected golf hole locations, wherein the plurality of selected golf hole locations comprises, for each physical golf green, one of the available golf hole locations, and the plurality of selected golf hole locations is selected such that a sum of the corresponding golf hole location scores corresponds to the desired overall course score; and
providing a set of golf hole location coordinates to a manager device, wherein the set of golf hole location coordinates is defined by the golf hole location coordinates of the selected golf hole locations and the set of golf hole location coordinates is usable to guide the cutting of golf holes on the plurality of physical golf greens.

2. The method of claim 1, further comprising:
generating the map of the plurality of physical golf greens using green location data that includes geolocation coordinates for the physical golf greens.

3. The method of claim 2, further comprising:
defining the golf hole location coordinates for each potential golf hole location as an absolute geolocation coordinate using the green location data.

4. The method of claim 1, further comprising, for each physical golf green in the plurality of golf greens:
receiving a plurality of user scores for a given potential golf hole location, wherein each user score is received from a user of the golf course, and each score corresponds to a score timeframe in which that given potential golf hole location is included in the set of selected golf hole locations in use; and
determining the corresponding golf hole location score for that given potential golf hole location based on the received user scores.

5. The method of claim 4, further comprising, for each physical golf green in the plurality of golf greens, repeating the process of receiving a plurality of user scores and determining the corresponding golf hole location score for the plurality of potential golf hole locations identified for that physical golf green.

6. The method of claim 4, further comprising:
determining the corresponding golf hole location score for the given potential golf hole location scores by:
generating a plurality of normalized user scores by normalizing each received user score based on user specific data from the user; and
determining the corresponding golf hole location score based on the plurality of normalized user scores.

7. The methods of claim 4, further comprising:
determining the corresponding golf hole location score for the given potential golf hole location scores by:
generating a plurality of adjusted user scores by adjusted each received user score based on score timeframe data for the received user score; and
determining the corresponding golf hole location score based on the plurality of adjusted user scores.

8. A method of managing golf hole locations on a golf course, the method comprising:
identifying a plurality of physical golf greens associated with the golf course;
generating a map of the plurality of physical golf greens, wherein the map defines, for each physical golf green, a perimeter of that physical golf green;
for each physical golf green:
identifying a plurality of potential golf hole locations, wherein each potential golf hole location is associated with corresponding golf hole location data, wherein the golf hole location data corresponding to each potential golf hole location specifies golf hole location coordinates for that potential golf hole location within the perimeter of the corresponding physical golf green; and
associating each potential golf hole location with a corresponding golf hole location score;
identifying at least one desired overall course score for the golf course;
selecting at least one set of selected golf hole locations for the golf course based on the at least one desired overall course score, wherein each set of selected golf hole locations comprises a plurality of selected golf hole locations, and the plurality of selected golf hole locations for each set of selected golf hole locations is selected such that a sum of the corresponding golf hole location scores correspond to the desired overall course score for that set of selected golf hole locations; and
providing a set of golf hole location coordinates to a manager device, wherein the set of golf hole location coordinates is defined by the golf hole location coordinates of the selected golf hole locations of a particular set of selected golf hole locations and the set of golf hole location coordinates is usable to guide the cutting of golf holes on the plurality of physical golf greens.

9. The method of claim 8, further comprising:
determining, for each physical golf green, a plurality of available golf hole locations from the plurality of potential golf hole locations associated with that physical golf green; and
selecting the plurality of selected golf hole locations from the plurality of available golf hole locations;
wherein for a given physical golf green, the plurality of available golf hole locations omits at least one of the potential golf hole locations for that physical golf green.

10. The method of claim 9, wherein for the given physical golf green, the plurality of available golf hole locations are determined by omitting all potential golf hole locations previously selected for that physical golf green within a predefined timeframe.

11. The method of claim 8, wherein the at least one overall course score comprises a single desired overall course score determined for a specified time frame.

12. The method of claim 8, wherein
the at least one desired overall course score comprises a plurality of desired overall course scores, wherein the plurality of desired overall course scores are selected for a sequence of specified time frames; and
selecting at least one set of golf hole locations comprises selecting a plurality of sets of selected golf hole locations corresponding to the plurality of desired overall course scores wherein each set of selected golf hole locations corresponds to one of the specified time frames in the sequence of specified time frames.

13. The method of claim 8, further comprising:
generating the map of the plurality of physical golf greens using green location data that includes geolocation coordinates for the physical golf greens.

14. The method of claim 13, further comprising:
defining the golf hole location coordinates for each potential golf hole location as an absolute geolocation coordinate using the green location data.

15. The method of claim 8, further comprising, for each physical golf green in the plurality of golf greens:
receiving a plurality of user scores for a given potential golf hole location, wherein each user score is received from a user of the golf course, and each score corresponds to a score timeframe in which that given potential golf hole location is included in the set of selected golf hole locations in use; and
determining the corresponding golf hole location score for that given potential golf hole location based on the received user scores.

16. The method of claim 15, further comprising, for each physical golf green in the plurality of golf greens, repeating the process of receiving a plurality of user scores and determining the corresponding golf hole location score for the plurality of potential golf hole locations identified for that physical golf green.

17. The method of claim 15, further comprising:
determining the corresponding golf hole location score for the given potential golf hole location scores by:
generating a plurality of normalized user scores by normalizing each received user score based on user specific data from the user; and
determining the corresponding golf hole location score based on the plurality of normalized user scores.

18. The methods of claim 15, further comprising:
determining the corresponding golf hole location score for the given potential golf hole location scores by:
generating a plurality of adjusted user scores by adjusted each received user score based on score timeframe data for the received user score; and
determining the corresponding golf hole location score based on the plurality of adjusted user scores.

19. A computer program product comprising a non-transitory computer readable medium storing computer executable instructions for configuring a processor to perform a method of managing golf hole locations on a golf course, wherein the method is defined according to claim 1.
